(19) United States
(12) Patent Application Publication
(10) Pub. No.: US 2012/0222562 A1
(43) Pub. Date: Sep. 6, 2012

(54) Food Steamer

(76) Inventor: Gaffar Mohammed, Windsor (CA)

(21) Appl. No.: 13/411,833

(22) Filed: Mar. 5, 2012

Related U.S. Application Data
(60) Provisional application No. 61/449,416, filed on Mar. 4, 2011.

(51) Int. Cl. A47J 27/04; A47J 36/10; A47J 36/06

(52) U.S. Cl. 99/341; 99/403; 99/417

(57) ABSTRACT

A steam cooker includes a base platter adapted to hold food items to be cooked and to be fit onto a pot for boiling water to generate steam confined in the pot by a lid. A steam funnel has a plug portion received through a central hole in the base platter to enter the pot interior and holds a condensed water collection vessel disposed below the base platter. A central tubular portion of the collector vessel allows steam to pass up and through a passage in the steam funnel to a steam chamber defined in a head portion and is directed out radially through steam outlets towards food to be cooked on the base platter. Condensed steam drains through to holes near the center of the base platter and into the collection chamber.

### CROSS REFERENCE TO RELATED APPLICATIONS

This application claims the benefit of U.S. provisional application No. 61/449,416 filed on Mar. 4, 2011, and is incorporated herein by reference.

### BACKGROUND OF THE INVENTION

This invention concerns food steamers widely used to cook vegetables, etc. by the use of steam, minimizing the use of cooking oils. In such devices, steam is generated to circulate over the food to items to cook the same. The steam produced is typically a “wet” unpressurized steam containing liquid water, which results in condensate on the food items, causing soggy waterlogged food. Long cooking periods are also usually required.

It is the object of the present invention to provide a food steamer which utilizes a slightly pressurized dry steam and effectively drains condensed water away from the food items being steamed to avoid soggy steamed food and also speeds the cooking process.

### SUMMARY OF THE INVENTION

The above object as well as other objects which will become apparent upon a reading of the following specification and claims are achieved by a steamer adapted to be placed on a pot containing water which is boiled on a stove to generate steam.

The steamer components include a dished base platter covering the pot and adapted to hold the food items to be cooked, which may be ribbed to allow ready draining of condensate beneath the food items being steamed, and also to minimize contact of the condensed water with the food items. The steam generated by water boiled in the pot is directed by a steam funnel into a cooking chamber defined in a space above the bases platter enclosed by a domed lid. A hollow steam funnel stem has a threaded lower plug end which can be installed on the base platter by being inserted into a central hole therein to reach an annular collector vessel mounted beneath the base platter, upwardly extending into which the steam funnel hollow lower plug end is threaded. The hollow plug steam funnel has a collar or shoulder which is drawn into engagement with a raised seat surrounding the hole to cause steam created by water boiling in the pot on which the base platter rests to pass up through the steam funnel.

A ball rests within the plug end on a convergent end wall of the steam funnel to allow steam to pass into a passage in the steam funnel stem only when the steam pressure reaches a sufficiently high level to lift the ball. The steam funnel has a steam chamber defined therein at the upper end or head of the steam funnel, which chamber has a plurality of steam jet outlets which direct streams or jets of steam outward and downward into the space towards the food items. The base platter covered by a lid secured to the base platter, which is in turn secured to the pot in which water is boiled as by two or more latches.

Drain holes are formed in the base platter arrayed around the hollow steam funnel allowing condensate to drain into the annular collector space located and below with the raised seat preventing water from reaching the plug end.

The steam funnel head preferably has a downwardly convex or conical inner top to reduce the volume of the chamber to thereby increase the velocity of steam flow to the jet outlets.

The steam funnel may be formed in separable parts to allow removal of a circular wire mesh placed on the base platter instead of integral ribs.

The steam assembly may be used with a pot similar to a pressure cooker having a lid which locks on the pot by flanges and recesses.

### DESCRIPTION OF THE DRAWING FIGURES

FIG. 1 is an exploded pictorial view of a first embodiment of a steamer component assembly according to the invention mounted on a cooking pot shown in which water may be boiled to generate steam utilized by the steam cooker.

FIG. 2 is an exploded perspective view of a second embodiment of a steamer component assembly according to the invention also mounted on a cooking pot.

FIG. 3 is a reduced size side view of a steamer component assembly having a reducer rim adapted to fit the steamer cooker to a smaller diameter pot.

FIG. 4 is an enlarged fragmentary sectional view of the inner region of the base platter, the lower plug end of the steamer funnel, and the annular collector vessel.

FIG. 5 is a side view of the steamer funnel and a fragmentary portion of a base platter with the steam flow paths indicated, and a cooking pot shown in phantom lines.

FIG. 6 is a pictorial view of a base platter included in the cooker with a circular mesh cooker to be deposited thereon in lieu of the rib features formed on the base platter.

FIG. 7 is an enlarged side view of a third embodiment of the steamer component cooker according to the invention.

FIG. 8 is an exploded pictorial view of a pressure cooker type pot with a steamer cooker components installed beneath a locking lid.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

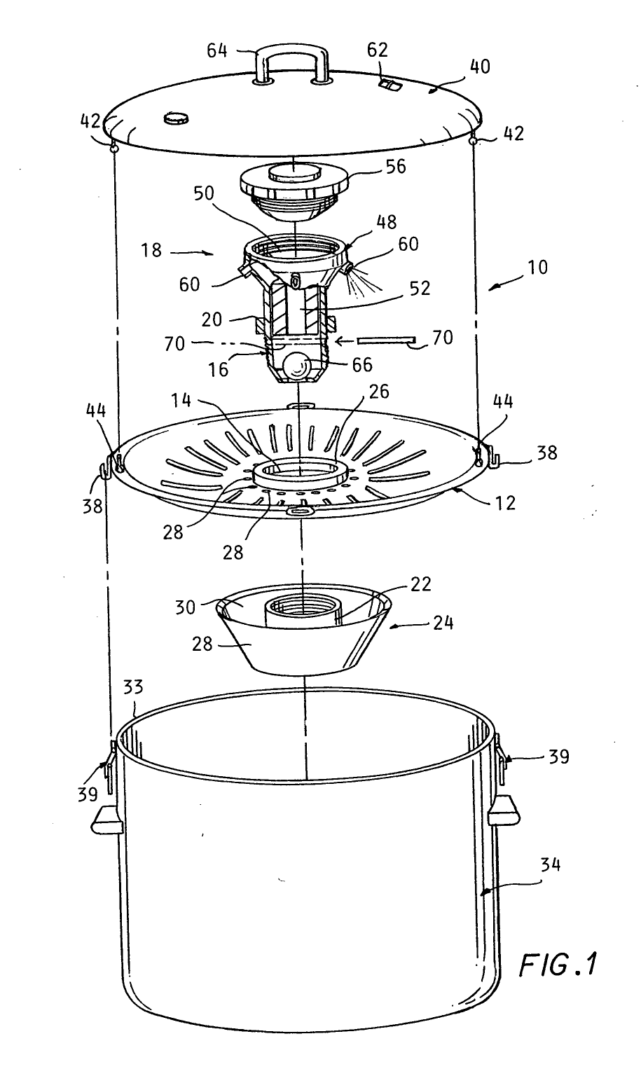

Referring to the drawings and particularly FIG. 1, a steamer cooker 10 according to the present invention is shown. The steamer cooker 10 includes a downwardly dished base platter 12 on which food items to be cooked are placed. A central round through hole 14 in the base platter 12 is sized to receive a partially threaded lower plug end 16 of a steam funnel 18 which rests on a radially outwardly collar 20 affixed to the outer diameter of the plug end 16 (or on an integral enlarged shoulder) at an intermediate location thereon.

The plug end 16 protrudes through the hole 14, and extends below the base platter 12 so that an internally threaded tubular spout 22 of a collector vessel 24 can receive the threaded lower portion of the plug end 16 and be threaded thereto to bring the collar 20 into engagement with an annular raised seat 26 on the upper surface of the base platter 12.

The collector vessel 24 includes an outer annular wall 28 which together with the tubular spout 22 and together with the under surface of the base platter 12 defines a closed condensate collection space 30. A series of drain holes 28 allow condensate collected on the base platter 12 to drain into annular space 30 of the collector vessel 24, with the raised seat 26 preventing condensate drainage flow to the central hole 14.

An internal through passage 32 in the tubular spout 22 allows steam generated by water boiled in a cooking pot 34 to pass up into the seam funnel 18.

The base platter 12 rests on the rim 33 of the pot 34. A plurality of hooks 38 may be provided on the outer perimeter of the base platter 12 adapted to catch a conventional over center linkage 39 well known in the field for use as a toolbox lock, etc, to allow latching the base platter onto the rim of the pot 34. Alternatively, the weight of the steamer component assembly 10 and base plate 12 may loosely seal the pot 34 to allow moderate steam pressure to build up therein.

The steamer cooker 10 also includes a domed lid 40, with retainer balls 42 fixed on downwardly extending pins attached to the perimeter of the lid 40 and when aligned received in keyhole openings 44 in the outer flattened rim perimeter of the base platter 12. Slight rotation of the lid 40 will then lock the lid 40 to the base platter 12.

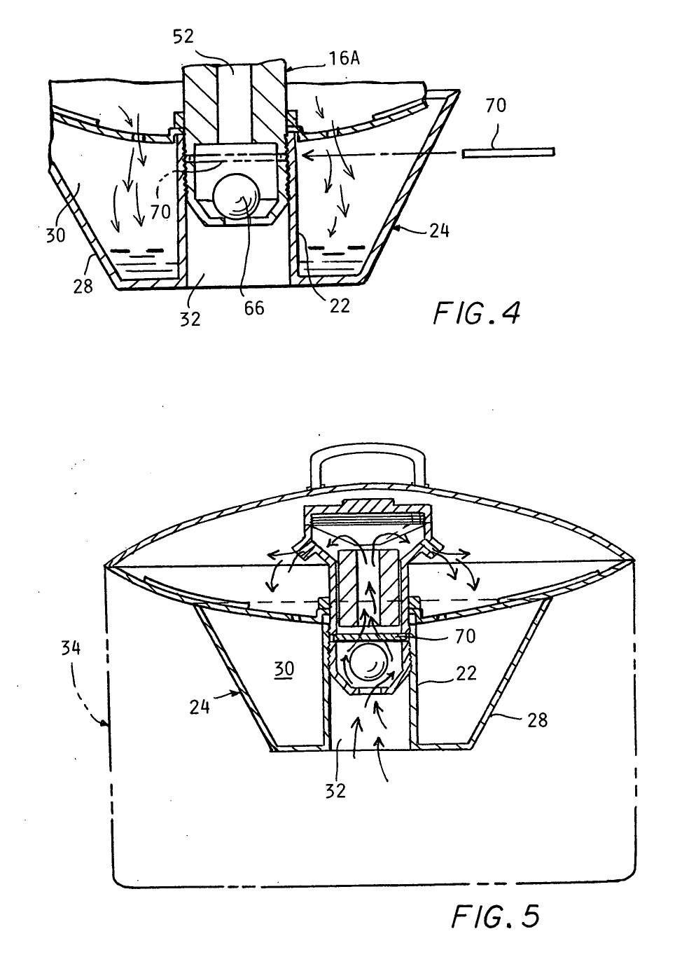

The steam funnel 18 includes a head portion 48 diverging from the upper end of the steam plug end 16 having an inner cavity 50 receiving steam through a bore 52 in heavy walled insert 54 or integrally formed). A cap 56 is threaded into the top of the cavity 50 and has a downwardly convex or conical surface 58 which reduces the volume of the cavity 50 to increase the flow rate of steam directed to outlet jets 60 arranged angled downwardly about the perimeter of the cavity 50 so that streams of steam will be directed at food on the base platter 12 (see FIGS. 4 and 5).

A selectively operable steam vent 62 is provided in the lid 40, as well as a handle 64. An overpressure releasing plug 65 could also be provided, although only a slight moderate pressure is allowed to be developed. When the water is boiled to create sufficient steam pressure, the steam pressure lifts a ball 66 acting as a weight to increase the steam pressure developed from a seat blocking an inlet hole 68 to allow steam to flow up through the bore 52. A cross pin 70 received in a bare through the plug end 16 limits the extent of upward movement of the ball 66.

Thus, streams of a dry steam under slight pressure will be produced which will gently and quickly cook the food items, with any condensate drained away and collected in the space 30 of the collector vessel 24.

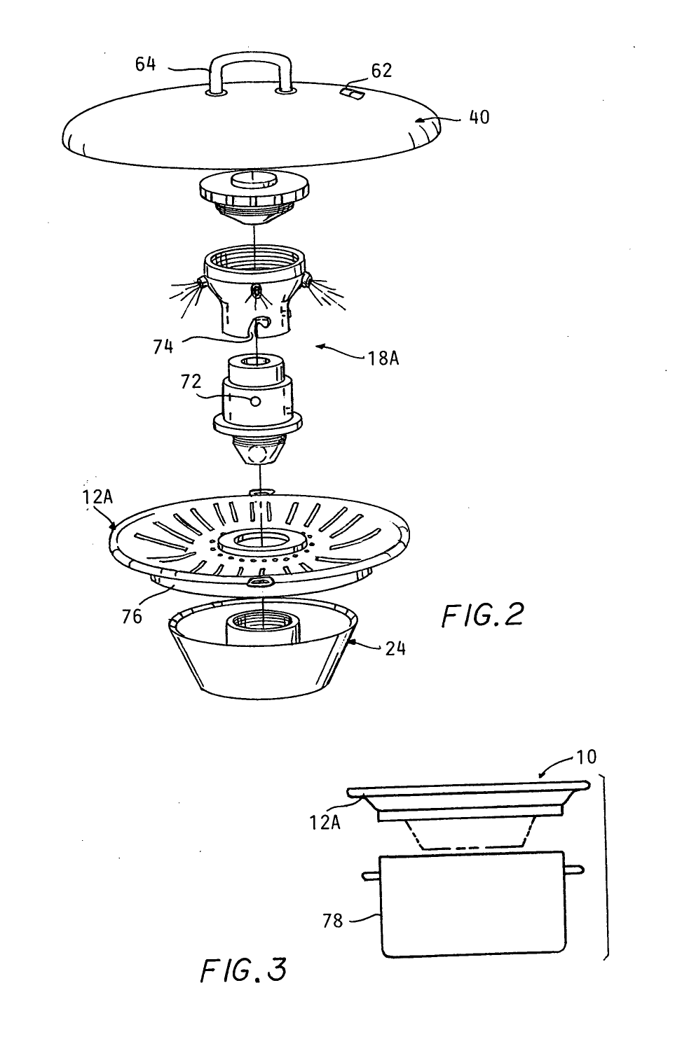

FIG. 2 shows a second embodiment in which a two part steam funnel 18A is shown, connectable together by a bayonet connection comprised of a radial pin 72 on the stem 16A and a slot 74 on the head.

The base platter 12A has a rim 76 affixed thereto which allows fitting to a smaller pot 78 (FIG. 3).

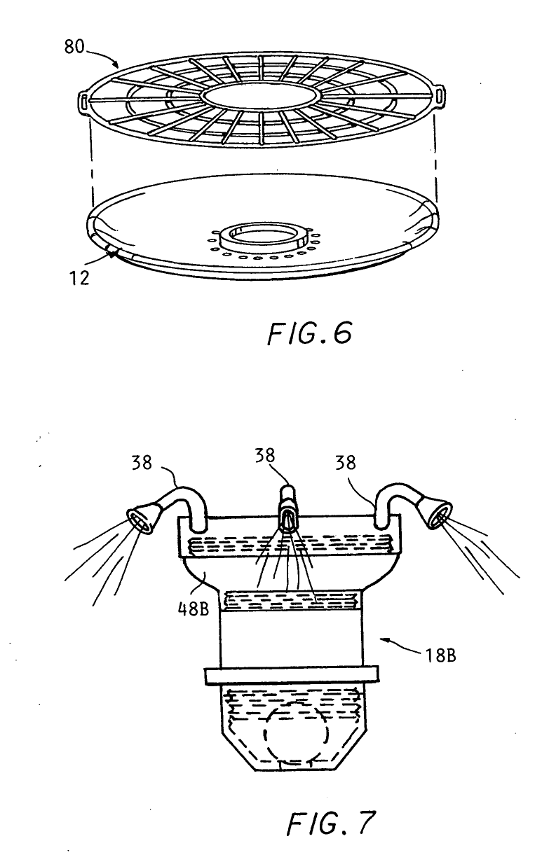

The two part construction will allow convenient removal of a circular wire mesh vegetable holder 80 (FIG. 6) which could also allow elimination of the ribs 28 shown in FIGS. 1 and 2.

FIG. 4 shows an alternative construction of an integral heavy walled steam funnel plug stem 16A instead of the separate insert 54 of FIGS. 1 and 2.

FIG. 7 shows a variation in which steam directing tubes 82 extend out from the head 48B of steam funnel 18B.

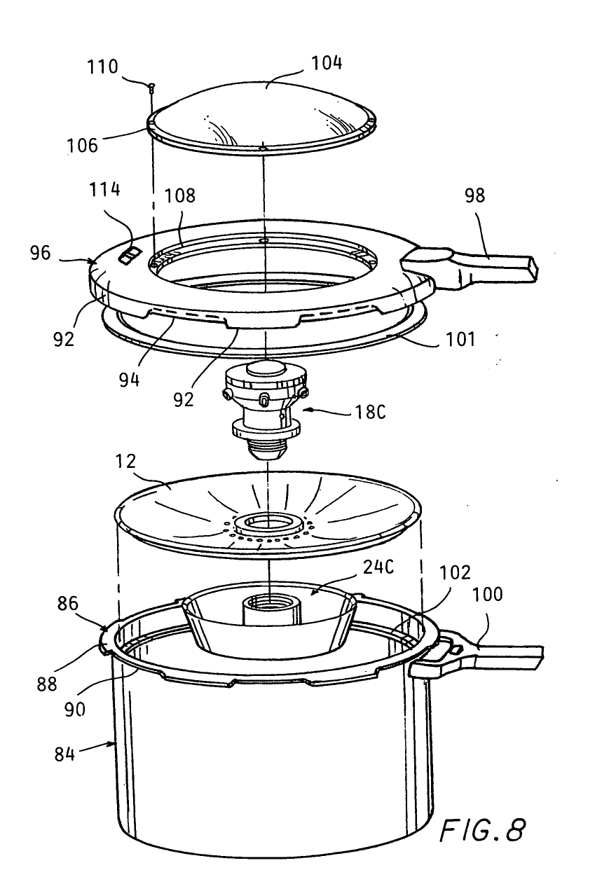

Referring to FIG. 8, an adaptation of the invention to a pot similar in construction of a conventional pressure cooker is shown. A modified pressure cooker type pot 84 has an upper rim 86 formed with radial tabs 88 and recesses 90 which interfit with complementary tabs 92 and recesses 94 on a lid 96. When the lid 96 is lowered onto the pot rim 86 with the tabs 92 aligned with recesses 90 and tabs 88 aligned with recesses 94, the tabs 92 are positioned below tabs 88. Rotation of the lid 96 using handles 98, 100 causes an action locking the lid 96 and tightly loosely sealing the pot 84. A gasket 101 could be provided.

A series of tabs 102 project radially inward from the pot wall at a level below the rim 86. A base platter 12C is sized to fit within the pot 84 and rest on a shoulder 102 so as to not interfere with the tab-recess camming action of the lid 96 and pot 84.

A collector vessel 24C and steam funnel component assembly 18C are provided as in the above described embodiments, assembled and functioning in a similar way. The pressure cooker lid 96 may have a transparent dome 104 instead of the conventional solid metal lid. The dome 104 is made of a clear high strength glass or plastic such as polycarbonate of an adequate thickness, and has a flattened rim 106. The rim 106 rests on a gasket on a recess 108 within the lid 96 and is secured with screws 110.

A steamer slidable pressure releasing window 114 is installed as in the embodiments described above.

Accordingly, a steamer cooker has been provided which will rapidly cook food items such as vegetables with dry steam while avoiding water logging of the steamed food items.

1. A food steamer comprising:
a pot for boiling water in an interior thereof;
a dished base platter adapted to hold food items to be steamed covering said pot lying over a rim of said pot;
a central hole in said base platter;
a steam funnel having a lower plug portion extending through said hole;
a collector vessel having a tubular portion received onto said plug portion lying below said base platter and variably positionable advanced thereon, said tubular portion having a through passage extending into communication with said pot interior to allow steam to flow therethrough, and said steam funnel plug portion having an internal passage in communication with said collector vessel tubular portion through passage;
said steam funnel having an upper head portion having a steam chamber receiving steam from water boiled in said pot via said through passages, and a plurality of jet outlets on said steam funnel head directing steam flow radially out of said steam chamber; and
a convex lid overlying said base platter to define together with said lid a closed cooking chamber isolated from said pot interior.

2. The food steamer according to claim 1 having one or more through holes in said base platter aligned with an annular portion of said collector vessel defining collector space allowing drainage of condensed steam out of said cooking chamber thereinto.

3. The food steamer according to claim 1 wherein said plug portion has a lower end wall formed with an outlet hole entering into said tubular portion through passage, and a movable closure element movable up by steam pressure to allow steam flow up through said outlet upon development of a predetermined steam pressure in said pot.

4. The food steamer according to claim 3 wherein said outlet hole is in the bottom of said end wall which is conical and said element comprises a ball resting in conical end wall.

5. The food steamer according to claim 1 wherein said collection vessel skirt portion abuts with an underside of said base platter to create a closed collection space by threading of said tubular portion onto said plug portion and engagement of a shoulder feature fixed on said plug lower portion.

6. The food steamer according to claim 1 wherein a plurality of raised ribs on an upper surface of said base platter extend radially towards said drainage holes from an outer region of said base platter.

7. The food steamer according to claim 1 wherein a circular wire mesh food holder rests on an upper surface of said base platter.

8. The food steamer according to claim 1 wherein said lid is formed with a window which can be opened to a variable degree to allow variable venting of steam from said cooking chamber.

9. The food steamer according to claim 4 wherein a stop cross pin is fixed in said plug portion spaced above said ball to limit upward movement of said ball.

10. The food steamer according to claim 1 wherein said head portion is larger in diameter than said stem portion formed with a steam chamber therein, said steam chamber having a downwardly convex upper inside top surface to reduce the confined space and thereby increase the velocity of steam flow to said outlet jets.

11. The food steamer according to claim 1 wherein said lid and base platter are held on a rim of said pot to prevent lifting off under pressure from steam in said pot

12. The food steamer according to claim 11 wherein said lid is releasably locked to said platter base and said platter base is latched to said pot with said platter base resting on said pot rim.

13. The food steamer according to claim 1 wherein said platter base rests on a shoulder recessed within said pot and said lid is attached to said pot by interfitting features engaging rotation of said lid on said pot.

14. The food steamer according to claim 13 wherein said lid includes a transparent dome.

15. The food steamer according to claim 1 wherein said base platter has a smaller diameter rim affixed to a bottom side of said lid fit to a pot of substantially smaller diameter than said base platter.
